(19) United States
(12) Patent Application Publication
(10) Pub. No.: US 2012/0231299 A1
(43) Pub. Date: Sep. 13, 2012

(54) MOLDED RIGID CASINGS FOR NON-ACTIVE COMPONENTS OF LITHIUM-POLYMER BATTERIES

(75) Inventors: Hongli Dai, Los Altos, CA (US); Richard M. Mank, Cupertino, CA (US)

(73) Assignee: APPLE INC., Cupertino, CA (US)

(21) Appl. No.: 13/041,979

(22) Filed: Mar. 7, 2011

(51) Int. Cl. H01M 2/00; H01M 2/30; H01M 10/04; H01M 2/08

(52) U.S. Cl. 429/7; 429/185; 429/179; 429/181; 29/623.2

(57) ABSTRACT

The disclosed embodiments provide a power source for use with a portable electronic device. The power source includes a battery cell sealed in a pouch along a terrace seal to form a sealed battery cell. The battery cell includes a cathode with an active coating, a separator, and an anode with an active coating. The power source also includes a rigid casing molded around a set of non-active components which include the terrace seal.

### BACKGROUND

1. Field

The disclosed embodiments relate to batteries for portable electronic devices. More specifically, the disclosed embodiments relate to a power source with a rigid casing molded around a set of inactive components in a lithium-polymer battery.

2. Related Art

Rechargeable batteries are presently used to provide power to a wide variety of portable electronic devices, including laptop computers, mobile phones, PDAs, digital music players and cordless power tools. The most commonly used type of rechargeable battery is a lithium battery, which can include a lithium-ion or a lithium-polymer battery.

Lithium-polymer batteries often include cells that are packaged in flexible pouches. Such pouches are typically lightweight and inexpensive to manufacture. Moreover, pouches may be tailored to various cell dimensions, allowing lithium-polymer batteries to be used in space-constrained portable electronic devices such as mobile phones, laptop computers, and/or digital cameras. For example, a lithium-polymer battery cell may achieve a packaging efficiency of 90-95% by enclosing a jelly roll and electrolyte in a foil pouch. Multiple pouches may then be placed side-by-side within a portable electronic device and electrically coupled in series and/or in parallel to form a battery for the portable electronic device. Because the enclosure for the portable electronic device provides physical protection for the pouches, the pouches may not require an additional battery enclosure, thus providing weight and space savings and/or increased battery capacity in the portable electronic device.

Conversely, the lack of a rigid, sealed battery enclosure may increase the susceptibility of lithium-polymer batteries to faults caused by mechanical stress, penetration, puncture, electrical shorts, and/or the intrusion of moisture or contaminants. Such faults may occur during assembly of the batteries, installation of the batteries in portable electronic devices, and/or use of the portable electronic devices. For example, an opening (e.g., puncture, incorrectly applied seal, etc.) in the pouch for a lithium-polymer battery may allow moisture and/or foreign material to enter the battery. The moisture and/or foreign material may additionally react with the electrolyte, cause a short circuit, and/or cause the battery to fail.

Hence, the use of portable electronic devices may be facilitated by mechanisms that improve the packaging efficiency, hermeticity, and/or resistance to mechanical stress of battery packs containing lithium-polymer battery cells.

### SUMMARY

The disclosed embodiments provide a power source for use with a portable electronic device. The power source includes battery cell sealed in a pouch along a terrace seal to form a sealed battery cell. The battery cell includes a cathode with an active coating, a separator, and an anode with an active coating. (Note that the battery cell can include a jelly roll or alternatively a stacked structure in which the anode/separator/cathode are stacked.) The power source also includes a rigid casing molded around a set of non-active components which include the terrace seal. (Note that this molding can involve injection molding, extrusion molding and compression molding.)

In some embodiments, the set of non-active components also includes a first conductive tab coupled to the cathode and a second conductive tab coupled to the anode. The first and second conductive tabs are extended through the terrace seal to provide terminals for the sealed battery cell.

In some embodiments, the set of non-active components further includes battery-support circuitry coupled to the first and second conductive tabs. The battery-support circuitry may include a safety circuit that monitors the battery cell for fault conditions such as an undervoltage, an overvoltage, and/or a short circuit. The battery-support circuitry may also include a set of switches used to charge, discharge, and/or disconnect the battery cell. Finally, the battery-support circuitry may include a gas-gauge circuit that obtains current, voltage, and/or temperature measurements from one or more sensors in the battery cell and uses the measurements to determine the state-of-charge, impedance, capacity, charging voltage, and/or remaining charge of the battery cell.

In some embodiments, the rigid casing contains thermoplastic or thermoset polymers. (Note that thermoset polymers can include Polyimide, polyepoxide, and polyoxybenzylmethylenglycolanhydride.)

In some embodiments, the rigid casing provides at least one of structural support and a hermetic seal around the non-active components.

### BRIEF DESCRIPTION OF THE FIGURES

FIG. 1 shows the placement of a battery in a computer system in accordance with an embodiment.

FIG. 2 shows a sealed battery cell in accordance with an embodiment.

FIG. 3 shows a top-down view of a power source in accordance with an embodiment.

FIG. 4 shows a cross-sectional view of a power source in accordance with an embodiment.

FIG. 5 shows a flowchart illustrating the process of manufacturing a sealed battery cell in accordance with an embodiment.

FIG. 6 shows a portable electronic device in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

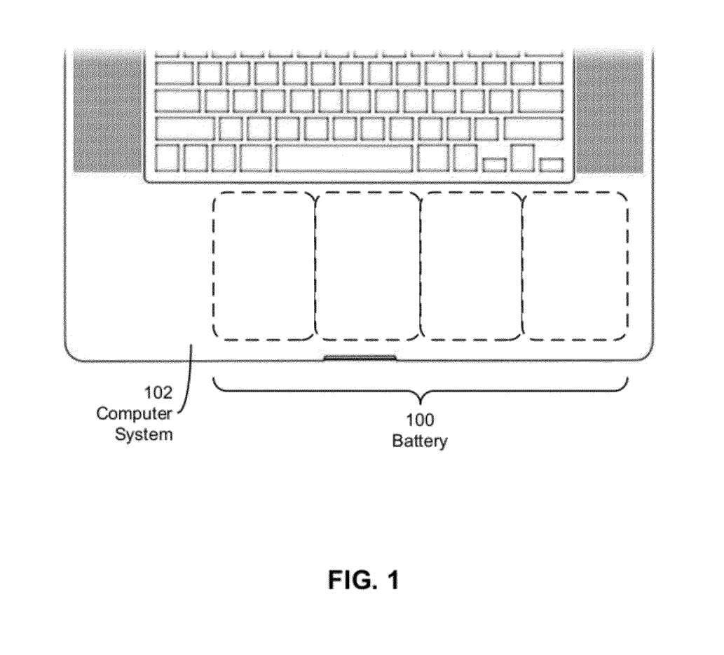

FIG. 1 shows the placement of a battery 100 in a computer system 102 in accordance with an embodiment. Computer system 102 may correspond to a laptop computer, personal digital assistant (PDA), portable media player, mobile phone, digital camera, tablet computer, and/or other portable electronic device. Battery 100 may correspond to a lithium-polymer battery and/or other type of power source for computer system 102. For example, battery 100 may correspond to a lithium-polymer battery that includes one or more cells packaged in flexible pouches. The cells may then be connected in series and/or in parallel and used to power computer system 102.

In one or more embodiments, battery 100 is designed to accommodate the space constraints of computer system 102. For example, battery 100 may include cells of different sizes and thicknesses that are placed side-by-side, top-to-bottom, and/or stacked within computer system 102 to fill up the free space within computer system 102. The use of space within computer system 102 may additionally be optimized by omitting a separate enclosure for battery 100. For example, battery 100 may include non-removable pouches of lithium-polymer cells encased directly within the enclosure for computer system 102. As a result, the cells of battery 100 may be larger than the cells of a comparable removable battery, which in turn may provide increased battery capacity and weight savings over the removable battery.

On the other hand, the elimination of a separate, sealed enclosure for battery 100 may increase the susceptibility of battery 100 to contamination and/or damage. First, battery 100 may be physically vulnerable until battery 100 is encased within the enclosure for computer system 102. In addition, sealing tape may be used to form individual cells within battery 100 and/or couple battery 100 to components in computer system 102. However, sealing tape may not provide adequate structural support for and/or a hermetic seal around battery 100 and/or the coupling of battery 100 to the components. Battery 100 may thus be susceptible to physical damage, moisture intrusion, and/or contamination during assembly, installation in computer system 102, and/or use of computer system 102.

In one or more embodiments, a rigid casing is disposed around non-active components of battery 100 to provide structural support and/or a hermetic seal around the non-active components. The rigid casing may be formed by injection-molding a thermoplastic resin around the non-active components. As discussed below, the rigid casing may mitigate physical damage, moisture intrusion, and/or contamination to battery 100 without negating the weight and/or capacity advantages associated with placing pouch cells directly within the enclosure for computer system 102.

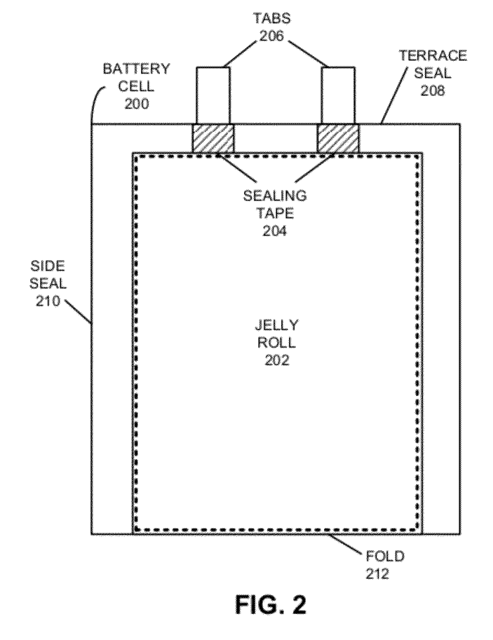

FIG. 2 shows a sealed battery cell 200 in accordance with an embodiment. Sealed battery cell 200 may correspond to a lithium-polymer cell that is used to power a portable electronic device. Sealed battery cell 200 includes a jelly roll 202 containing a number of layers which are wound together, including a cathode with an active coating, a separator, and an anode with an active coating. More specifically, jelly roll 202 may include one strip of cathode material (e.g., aluminum foil coated with a lithium compound) and one strip of anode material (e.g., copper foil coated with carbon) separated by one strip of separator material (e.g., conducting polymer electrolyte). The cathode, anode, and separator layers may then be wound on a mandrel to form a spirally wound structure. Jelly rolls are well known in the art and will not be described further.

During assembly of sealed battery cell 200, jelly roll 202 is enclosed in a flexible pouch, which is formed by folding a flexible sheet along a fold line 212. For example, the flexible sheet may be made of aluminum with a polymer film, such as polypropylene. After the flexible sheet is folded, the flexible sheet can be sealed, for example by applying heat along a side seal 210 and along a terrace seal 208.

Jelly roll 202 also includes a set of conductive tabs 206 coupled to the cathode and the anode. Conductive tabs 206 may extend through seals in the pouch (for example, formed using sealing tape 204) to provide terminals for sealed battery cell 200. Conductive tabs 206 may then be used to electrically couple sealed battery cell 200 with one or more other sealed battery cells to form a battery pack. For example, the battery pack may be formed by coupling the sealed battery cells in a series, parallel, or series-and-parallel configuration.

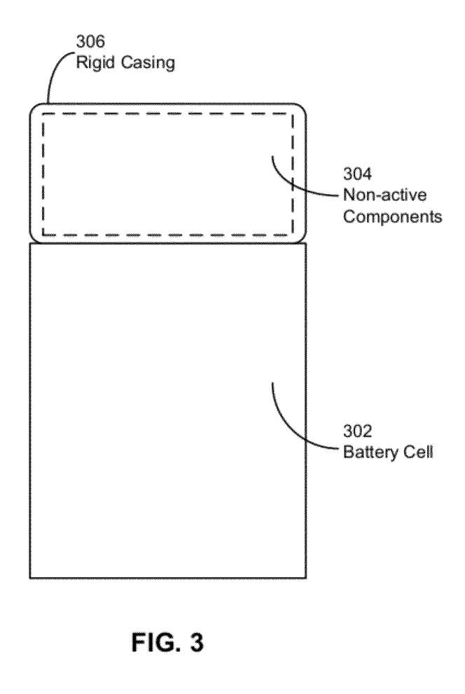

FIG. 3 shows a top-down view of a power source in accordance with an embodiment. As shown in FIG. 3, the power source includes a sealed battery cell 302, a set of non-active components 304, and a rigid casing 306 disposed around non-active components 304.

As mentioned previously, sealed battery cell 302 may correspond to a lithium-polymer battery cell. Consequently, sealed battery cell 302 may be packaged in a flexible pouch instead of a sealed, rigid battery enclosure. In addition, sealing tape may be used to seal the sealed battery cell 302 in the pouch and/or couple non-active components 304 to one another.

Non-active components 304 may include components that do not participate in the electrochemical charge/discharge reaction of sealed battery cell 302. For example, non-active components 304 may correspond to the terrace seal of the pouch; conductive tabs that extend through the terrace seal; battery-support circuitry such as a safety circuit, a set of switches, and/or a gas-gauge circuit; and/or connector components such as wires, traces, cables, printed circuits, and/or welding pads.

To physically protect and/or hermetically seal non-active components 304 without reducing the size and/or capacity of sealed battery cell 302, rigid casing 306 may be injection-molded around non-active components 304 but not around sealed battery cell 302. Rigid casing 306 may contain a thermoplastic resin may contain a thermoplastic resin, such as Polyethylene terephthalate (PET), Polyoxymethylene (POM), Polyacrylate, and/or polyamide. For example, rigid casing 306 may be formed by insert-injection molding a nylon-based resin to non-active components 304 after sealed battery cell 302 is coupled to battery-support circuitry via the conductive tabs.

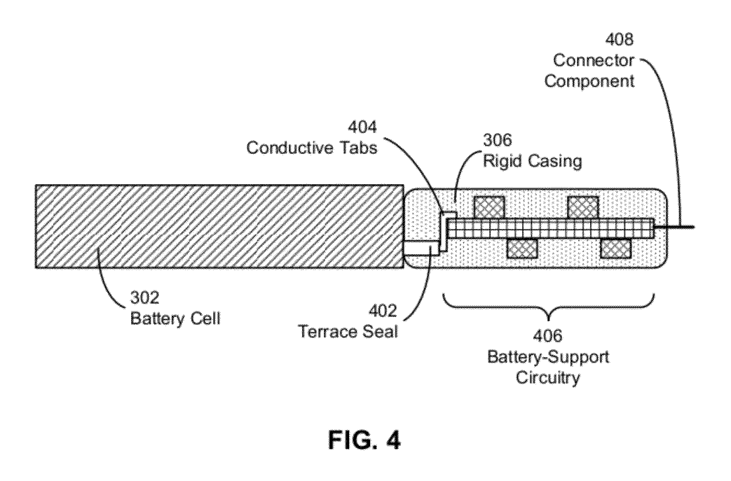

FIG. 4 shows a cross-sectional view of a power source in accordance with an embodiment. More specifically, FIG. 4 shows the formation of rigid casing 306 around a set of non-active components (e.g., non-active components 304 of FIG. 3) in a power source (e.g., battery pack) containing sealed battery cell 302. The non-active components may include a terrace seal 402, a set of conductive tabs 404, battery-support circuitry 406, and a connector component 408.

To enable charging, discharging, and/or monitoring of sealed battery cell 302, conductive tabs 404 may be coupled to battery-support circuitry 406. Battery-support circuitry 406 may include a safety circuit that monitors the voltage and/or current of sealed battery cell 302 for fault conditions such as an overvoltage, undervoltage, and/or short circuit in sealed battery cell 302. Battery-support circuitry 406 may also include a set of switches used to charge, discharge, and/or disconnect sealed battery cell 302. Finally, battery-support circuitry 406 may include a gas-gauge circuit that obtains current, voltage, and/or temperature measurements from one or more sensors in sealed battery cell 302 and uses the measurements to determine the state-of-charge, impedance, capacity, charging voltage, and/or remaining charge of sealed battery cell 302.

A connector component 408 may extend out of rigid casing 306 to couple sealed battery cell 302 to a load such as a portable electronic device. For example, connector component 408 may include a wire that connects sealed battery cell 302 and battery-support circuitry 406 to a main logic board (MLB) of a laptop computer.

As described above, rigid casing 306 may provide structural support and/or a hermetic seal around the non-active components. In particular, rigid casing 306 may be injection-molded (e.g., insert-injection-molded) around the non-active components to completely encase the non-active components in a thermoplastic resin. At the same time, rigid casing 306 may be formed in a way that does not encroach on the space occupied by sealed battery cell 302, thus maintaining the increased capacity and/or weight savings associated with enclosing sealed battery cell 302 directly within an enclosure for the portable electronic device.

As a result, rigid casing 306 may physically protect the non-active components by maintaining the physical arrangement and connection of the non-active components and isolating the non-active components completely from the surrounding environment. Furthermore, automation of the injection-molding process may allow the formation of rigid casing 306 to reduce the overhead associated with manually applying sealing tape to couple non-active components in a battery pack. Finally, because rigid casing 306 occupies space that is normally unused (e.g., due to vicinity to components in battery-support circuitry 406), rigid casing 306 may not detract from the efficient use of space in the portable electronic device. For example, rigid casing 306 may not affect the placement, dimensions, and/or capacity of sealed battery cell 302 within the portable electronic device. In other words, rigid casing 306 may provide a cost- and space-effective mechanism for physically supporting and/or hermetically sealing non-active components in power sources for portable electronic devices.

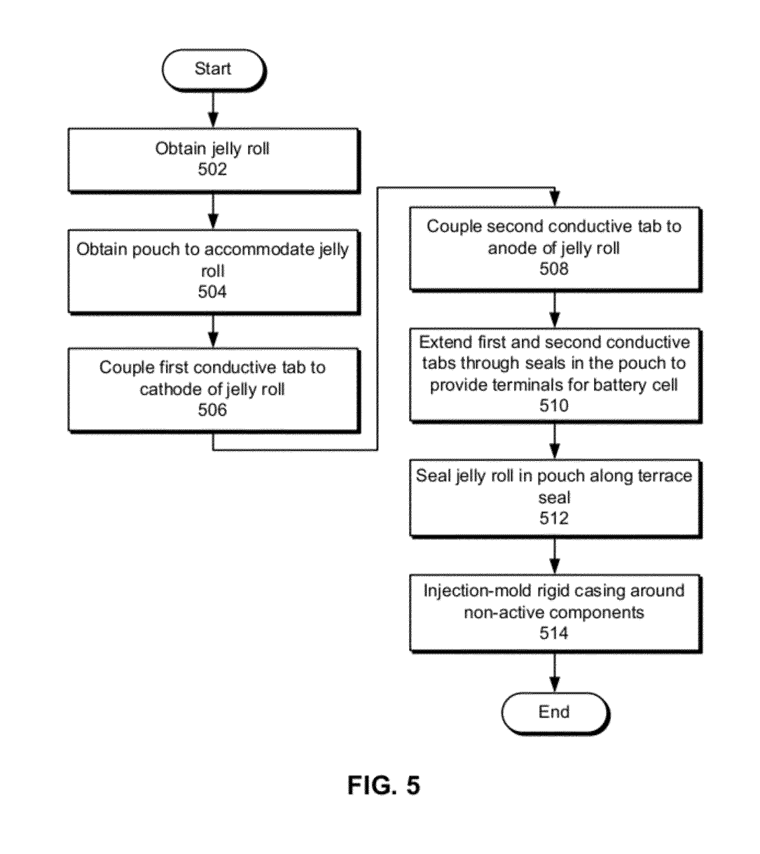

FIG. 5 shows a flowchart illustrating the process of manufacturing a sealed battery cell in accordance with an embodiment. In one or more embodiments, one or more of the steps may be omitted, repeated, and/or performed in a different order. Accordingly, the specific arrangement of steps shown in FIG. 5 should not be construed as limiting the scope of the embodiments.

First, a jelly roll is obtained (operation 502). The jelly roll may include a cathode with an active coating, a separator, and an anode with an active coating. A pouch to accommodate the jelly roll is also obtained (operation 504). Next, a first conductive tab is coupled to the cathode of the jelly roll (operation 506), and a second conductive tab is coupled to the anode of the jelly roll (operation 508). The first and second conductive tabs are extended through seals in the pouch to provide terminals for the sealed battery cell (operation 510), and the jelly roll is sealed in the pouch along a terrace seal (operation 512). For example, the jelly roll may be sealed by spot welding and/or applying heat to the seals.

Finally, a rigid casing is injection-molded around a set of non-active components (operation 514). The non-active components may include the conductive tabs; battery-support circuitry coupled to the conductive tabs, such as a safety circuit, a set of switches, and/or a gas-gauge circuit; and/or conductive components such as wires, traces, cables, printed circuits, and/or welding pads. The rigid casing may contain a thermoplastic resin that is formed around the non-active components after the conductive tabs are coupled to the battery-support circuitry. Because the rigid casing does not enclose the sealed battery cell, the rigid casing may provide structural support and/or a hermetic seal around the non-active components without reducing the size and/or capacity of the sealed battery cell.

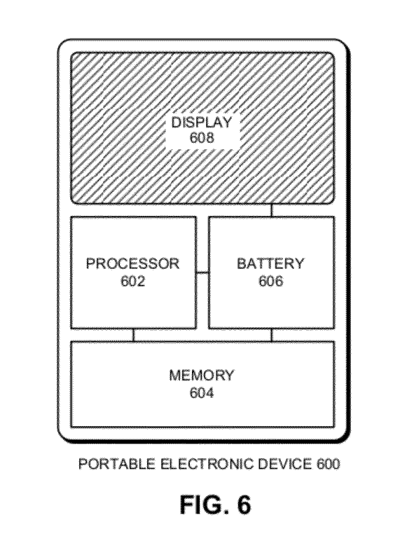

The above-described rechargeable sealed battery cell can generally be used in any type of electronic device. For example, FIG. 6 illustrates a portable electronic device 600 which includes a processor 602, a memory 604 and a display 608, which are all powered by a battery 606. Portable electronic device 600 may correspond to a laptop computer, mobile phone, PDA, tablet computer, portable media player, digital camera, and/or other type of battery-powered electronic device. Battery 606 may correspond to a battery pack that includes one or more sealed battery cells. Each sealed battery cell may include a jelly roll sealed in a pouch along a terrace seal. The battery pack may also include a rigid casing disposed around a set of non-active components that include the terrace seal, conductive tabs extending through the terrace seal, and/or battery-support circuitry for the battery pack.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A power source, comprising:
a battery cell, including a cathode with an active coating, a separator, and an anode with an active coating;
a pouch enclosing the battery cell, wherein the battery cell is sealed in the pouch along a terrace seal to form a sealed battery cell; and
a rigid casing molded around a set of non-active components, wherein the set of non-active components comprises the terrace seal.

2. The power source of claim 1, wherein the set of non-active components further comprises:
a first conductive tab coupled to the cathode; and
a second conductive tab coupled to the anode,
wherein the first and second conductive tabs extend through the terrace seal to provide terminals for the sealed battery cell.

3. The power source of claim 2, wherein the set of non-active components further comprises:
battery-support circuitry coupled to the first and second conductive tabs.

4. The power source of claim 3, wherein the battery-support circuitry comprises:
a safety circuit; and
a set of switches.

5. The power source of claim 4, wherein the battery-support circuitry further comprises:
a gas-gauge circuit.

6. The power source of claim 1, wherein the rigid casing comprises thermoplastic or thermoset polymers.

7. The power source of claim 1, wherein the rigid casing provides at least one of structural support and a hermetic seal around the non-active components.

8. A method for manufacturing a sealed battery cell, comprising:
obtaining a battery cell including a cathode with an active coating, a separator, and an anode with an active coating, wherein the battery cell includes a first conductive tab coupled to the cathode and a second conductive tab coupled to the anode;
obtaining a pouch to accommodate the cell;
sealing the battery cell in the pouch along a terrace seal; and
molding a rigid casing around a set of non-active components, wherein the set of non-active components comprises the first and second conductive tabs and the terrace seal.

9. The method of claim 8, wherein the set of non-active components further comprises:
battery-support circuitry coupled to the first and second conductive tabs.

10. The method of claim 9, wherein the battery-support circuitry comprises:
a safety circuit; and
a set of switches.

11. The method of claim 8, wherein the rigid casing comprises thermoplastic or thermoset polymers.

12. A battery pack, comprising:
a sealed battery cell, comprising:
a battery cell, including a cathode with an active coating, a separator, and an anode with an active coating;
a first conductive tab coupled to the cathode;
a second conductive tab coupled to the anode; and
a pouch enclosing the sealed battery cell, wherein the battery cell is sealed in the pouch along a terrace seal; and
a rigid casing molded around a set of non-active components, wherein the set of non-active components comprises the first and second conductive tabs and the terrace seal.

13. The battery pack of claim 12, wherein the set of non-active components further comprises:
battery-support circuitry coupled to the first and second conductive tabs.

14. The battery pack of claim 13, wherein the battery-support circuitry comprises:
a safety circuit; and
a set of switches.

15. The battery pack of claim 14, wherein the battery-support circuitry further comprises:
a gas-gauge circuit.

16. The battery pack of claim 12, wherein the rigid casing comprises thermoplastic or thermoset polymers.

17. A portable electronic device, comprising:
a set of components powered by a battery pack; and
the battery pack, comprising:
a sealed battery cell, comprising:
a battery cell, including a cathode with an active coating, a separator, and an anode with an active coating; and
a pouch enclosing the sealed battery cell, wherein the battery cell is sealed in the pouch along a terrace seal; and
a rigid casing molded around a set of non-active components, wherein the set of non-active components comprises the terrace seal.

18. The portable electronic device of claim 17, wherein the set of non-active components further comprises:
a first conductive tab coupled to the cathode; and
a second conductive tab coupled to the anode,
wherein the first and second conductive tabs extend through the terrace seal to provide terminals for the sealed battery cell.

19. The portable electronic device of claim 18, wherein the set of non-active components further comprises:
battery-support circuitry coupled to the first and second conductive tabs.

20. The portable electronic device of claim 19, wherein the battery-support circuitry comprises:
a safety circuit; and
a set of switches.

21. The portable electronic device of claim 20, wherein the battery-support circuitry further comprises:
a gas-gauge circuit.

22. The portable electronic device of claim 17, wherein the rigid casing comprises thermoplastic or thermoset polymers.
